(19) United States
(12) Patent Application Publication
(10) Pub. No.: US 2008/0160232 A1
(43) Pub. Date: Jul. 3, 2008

(54) Ink Jet Recording Sheet

(75) Inventors: Nobuyasu Sasaguri, Tokyo (JP); Takashi Okazaki, Chiba (JP); Syunsuke Shioi, Saitama (JP)

Correspondence Address: KRATZ, QUINTOS & HANSON, LLP, 1420 K Street, N.W., Suite 400, WASHINGTON, DC, 20005, US

(73) Assignee: OJI PAPER CO., LTD., Tokyo (JP)

(21) Appl. No.: 11/794,147

(22) PCT Filed: Jan. 4, 2006
(86) PCT No.: PCT/JP2006/300155

§ 371 Date: Jun. 26, 2007

(30) Foreign Application Priority Data
Jan. 11, 2005 (JP) 2005-003944
Jan. 26, 2005 (JP) 2005-017906

(51) Int. Cl. B41M 5/40

(52) U.S. Cl. 428/32.33; 428/32.34; 428/32.35

(57) ABSTRACT

The present invention relates to an ink jet recording sheet comprising a sheet-like substrate, and an ink receiving layer formed on at least one surface of the sheet-like substrate, the ink receiving layer containing an amorphous silica having an average particle size 0.5 to 10 μm and a binder, the sheet-like substrate being subjected to a calendering treatment after forming the ink receiving layer thereon, thereby white-paper gloss of the recording sheet measured at 75° in accordance with JIS Z 8741 is from 30 to 90%.

### TECHNICAL FIELD

An object of the present invention is to provide an ink jet recording sheet best suited for on-demand printing, which is inexpensive and also has high white-paper gloss.

### BACKGROUND ART

An ink jet recording system, in which fine droplets of an ink are injected onto a recording sheet so as to form images thereon, is capable of easily achieving high-speed recording of multi-color images with low noise and eliminates the need for developing and fixing steps. As such, the ink jet recording system has been rapidly proliferating as a method for recording color images in various applications. In particular, it is predominantly used as the means for forming images generated by personal computers on recording paper. In recent years, with advancements in technology to control ink droplets and improvements in the quality of recording sheets, picture quality of ink jet recording has improved to a level comparable to that of a silver halide film photograph.

Furthermore, in the field of commercial printing, the ink jet recording system has been increasingly applied to on-demand printing which prints images on media such as paper directly from digital information without preparing a printing plate and is therefore best suited to printing of small volume or variable information printing (variable printing). With this trend, an ink jet recording system equipped with a line head has been attracting much attention due to a very high printing speed.

There have been improvements made on hardware and ink composition, so as to enable it to use high-quality paper and coated paper manufactured for use in handwriting and ordinary printing, as the recording sheet used in the ink jet recording method. However, increasing requirements for advanced properties have been imposed on recording sheets with a trend for hardware for a higher printing speed and higher resolution, advancements in the performance of the ink jet recording machines such as full-color printing and expansion of applications for such machines. Specifically, recording sheets for use with a high density of printed dots with bright and clear color tone, quick absorption of ink without oozing or blurring even when the printed dots are superposed, restriction of lateral diffusion of printed dots with a smooth and clear boundary, etc. in order to achieve high image reproducibility.

Especially for on-demand printing, which is intended for business use rather than personal use, the paper used in printing is required to have a white-paper gloss and low price that are proximate to those of ordinary coated paper used in offset printing, in addition to the properties described above. The paper used in on-demand printing is also required to have high surface strength, since the field of application overlaps with that of offset printing.

There has been no recording sheet intended for ink jet printing which satisfies the requirements for a recording sheet of ink jet printing in an on-demand printing operation.

The recording sheet often has an ink receiving layer formed of a material which contains porous inorganic pigments such as silica having water and oil absorptivity. Although a sheet having high white-paper gloss has been obtained, either by using an ultra-fine silica powder having an average particle size of several hundreds of nanometers, which has a smooth surface layer, or by manufacturing by a casting process, material and manufacturing cost are high and it is difficult to make inexpensive paper appropriate for an on-demand printing application (see, for example, Japanese Unexamined Patent Publication (Kokai) No. 11-208103 and Japanese Unexamined Patent Publication (Kokai) No. 11-268405). On the other hand, when a low-cost silica powder having an average particle size within a range from 1 to several tens of micrometers is used, high water absorptivity is achieved, but white-paper gloss becomes very poor (see, for example, Japanese Unexamined Patent Publication No. S55-51583 and Japanese Unexamined Patent Publication No. 2000-335092). It is a common practice in the paper mill industry, to apply a calendering treatment after coating in order to improve white-paper gloss. However, in the case of a recording sheet for ink jet printing, this method of applying the pressure of calendering treatment to the sheet thereby reducing the pores in the ink receiving layer and decreasing ink absorptivity is not employed, since high water and oil absorptivity is required. In addition, many porous inorganic pigments have a structure formed by secondary aggregation which is brittle. Therefore, much of the porous inorganic pigments contained in the ink receiving layer may break down under pressure depending on the conditions of the calendering treatment, thus resulting in very low surface strength which easily breaks when bent. Moreover, in case of paper which has low surface strength, often it may not be applicable for use in a field similar to that of offset printing. Another known method of improving white-paper gloss is to use a binder made of latex having a particular glass transition temperature and carry out a heated calendering treatment under relatively low pressure. However, since white-paper gloss undergoes variation due to slight fluctuation in the treating temperature, it is difficult to obtain a sheet having a stable white-paper gloss. In addition, this method has a problem in that extra energy of heating is required (see, for example, Japanese Unexamined Patent Publication (Kokai) No. 57-93193).

An amorphous silica obtained by a vapor phase process or a wet process is excellent in performances and it is known that a wet-process silica obtained by adding sulfuric acid in an aqueous sodium silicate solution (see, for example, Japanese Unexamined Patent Publication (Kokai) No. 10-329412 and Japanese Unexamined Patent Publication (Kokai) No. 9-95042) is comparatively cheap and therefore can be used for on-demand printing. However, this method is a method comprising adjusting particle size and particle size distribution by drying after a neutralization reaction, followed by dry grinding and further classification, and thus the production process required to obtain a product is long and complicated and causes a lot of loss of products during the processes, and thus yield is low. Therefore, it cannot be said that the resulting product is not inexpensive. Also, since the amorphous silica as a product is a powder, a powder scatters when preparing a coating material for an ink jet sheet using a stirrer, such as Cowless dissolver, and is also inferior in handling properties.

As a method of improving handling properties of a silica powder, for example, there is known a method comprising stepwisely neutralizing sodium silicate with mineral acid in three stages and subjecting the sodium silicate to a wet grinding treatment during aging after neutralization at the first stage to obtain a silica dispersion element (see, for example, Japanese Unexamined Patent Publication (Kokai) No. 8-91820) and a method comprising subjecting an aqueous sodium silicate solution heated to 60° C. or higher to a wet grinding treatment during the reaction time until the amount reaches an amount corresponding to 70 to 100% of a neutralization equivalent while continuously adding mineral acid, and adjusting the pH value within a range from 8 to 3 to obtain a silica dispersion element (see, for example, Japanese Unexamined Patent Publication (Kokai) No. 2004-299936). However, it has been found that, when the silica dispersion element obtained by the method is used as a pigment for an ink receiving layer, a product having both excellent white-paper gloss and excellent color developability cannot be obtained even when subjected to a calendering treatment.

### DISCLOSURE OF THE INVENTION

A first object of the present invention is to provide an ink jet recording sheet which is inexpensive and also has high white-paper gloss and high surface strength. Also, a second object of the present invention is to provide an ink jet recording sheet best suited for on-demand printing, which is excellent in handling properties of pigment upon preparation of a coating material and is also excellent in white-paper gloss and color developability.

The present inventors have carried out extensive studies for the purpose of developing an ink jet recording sheet, which is inexpensive and also has high white-paper gloss, and found that both white-paper gloss and surface strength can be enhanced by using an inexpensive amorphous silica having an average particle size of 0.5 to 10 μm, and preferably more than 4 μm and 10 μm or less in an ink receiving layer of the ink jet recording sheet, thus completing the following inventions (1) to (4):

(1) An ink jet recording sheet comprising a sheet-like substrate, and an ink receiving layer formed on at least one surface of the sheet-like substrate, the ink receiving layer containing an amorphous silica having an average particle size 0.5 to 10 μm and a binder, the sheet-like substrate being subjected to a calendering treatment after forming the ink receiving layer thereon, thereby the white-paper gloss of the recording sheet measured at 75° in accordance with JIS Z 8741 is from 30 to 90%;
(2) The ink jet recording sheet according to (1), wherein the average particle size of the amorphous silica is more than 4 μm and 10 μm or less;
(3) The ink jet recording sheet according to (1) or (2), wherein the amorphous silica is a wet-process silica; and
(4) The ink jet recording sheet according to (3), wherein the wet-process silica is prepared without passing through the drying step during the preparation.

Also, the present inventors have carried out extensive studies for the purpose of developing an ink jet recording sheet, which is excellent in handling properties of a pigment upon preparation of a coating material, and is also excellent in white-paper gloss and color developability, and found that a silica best suited for use as a material of a coating solution for ink receiving layer of an ink jet recording sheet can be obtained by preliminarily adding sodium sulfate to an aqueous sodium silicate solution before initiation of neutralization with mineral acid, and adding mineral acid in two stages, thus completing the following inventions (5) to (10):

(5) An ink jet recording sheet comprising a substrate, and an ink receiving layer formed on the surface of the substrate, the ink receiving layer containing a wet-process silica and a binder, wherein the wet-process silica is obtained by adding mineral acid having a neutralization equivalent of 35 to 45% to an aqueous sodium silicate solution containing sodium sulfate added preliminarily therein at a first stage, thereby partially neutralizing the aqueous sodium silicate solution, adjusting the concentration of silicon dioxide in the aqueous solution within a range from 6.0 to 8.0 g/100 ml and adjusting the concentration of sodium sulfate within a range from 3.5 to 4.1 g/100 ml, heating the aqueous solution to a temperature within a range of 85 to 95° C. with stirring, and adding mineral acid at a second stage, thereby completing neutralization, and the wet-process silica is obtained without passing through a drying step;
(6) The ink jet recording sheet according to (5), wherein the wet-process silica is obtained by adding mineral acid at the second stage, thereby completing neutralization and wet-grinding and/or wet-classifying the resulting slurry, and the wet-process silica is obtained without passing trough the drying step;
(7) The ink jet recording sheet according to (5), wherein the wet-process silica is obtained by adding mineral acid at the second stage, thereby completing neutralization, filtering the aqueous solution to obtain a silica cake and dispersing the silica cake again in water, and the wet-process silica is obtained without passing trough the drying step;
(8) The ink jet recording sheet according to (7) wherein the wet-process silica is obtained by adding mineral acid at the second stage, thereby completing neutralization, filtering the aqueous solution to obtain a silica cake, washing the silica cake with water and dispersing the silica cake again in water, and the wet-process silica is obtained without passing through the drying step;
(9) The ink jet recording sheet according to any one of claims (7) to (8), wherein the wet-process silica is obtained by adding mineral acid at the second stage, thereby completing neutralization, filtering the aqueous solution to obtain a silica cake, washing the silica cake with water or not, dispersing the silica cake again in water and wet grinding and/or wet classifying the silica cake, and the wet-process silica is obtained without passing through the drying step; and
(10) The ink jet recording sheet according to any one of (5) to (9), wherein wet-process silica has an average particle size within a range from 0.2 to 10 μm and particles having a particle size of 30 μm or less account for 70% or more of the entire particles.

The ink jet recording sheet characterized by containing an amorphous silica in an ink receiving layer is excellent in ink absorptivity and has high white-paper gloss and high surface strength, and is also inexpensive, and is therefore extremely useful in practice. Also, the ink jet recording sheet characterized by containing a wet-process silica in an ink receiving layer of the present invention is an ink jet recording sheet best suited for on-demand printing, which is excellent in handling properties of a pigment upon preparation of a coating material and is also excellent in white-paper gloss and color developability, and therefore this ink jet recording sheet is also extremely useful in practice.

### BEST MODE FOR CARRYING OUT THE INVENTION

### Ink Jet Recording Sheet Characterized by Containing Amorphous Silica in Ink Receiving Layer

Examples of the amorphous silica, which can be used in the ink receiving layer of the ink jet recording sheet characterized by containing the amorphous silica in the ink receiving layer, include wet-process silica and vapor phase-process silica.

The wet-process silica is usually prepared by reacting sodium silicate with sulfuric acid under an alkali condition or an acidic condition, followed by passing through filtration, water washing, drying, and grinding/classification steps. The vapor phase-process silica is usually prepared by a flame hydrolysis method. Specifically, the vapor phase-process silica is prepared by burning silicon tetrachloride together with hydrogen and oxygen.

Examples of commercially available products of the wet-process silica include Nipsil manufactured by Nippon Silica Industrial Co., Ltd., Tokuseal manufactured by TOKUYAMA Corp. and Mizukasil manufactured by MIZUSAWA INDUSTRIAL CHEMICALS, LTD. Examples of commercially available products of the vapor phase-process silica include Aerogyl manufactured by Japan Aerogyl Co., Ltd. and QS type manufactured by TOKUYAMA Corp.

The average particle size of the amorphous silica is preferably from 0.5 to 10 μm, and particularly preferably larger than 4 μm, and up to 10 μm. When the average particle size is more than 10 μm, the amorphous silica is likely to be broken by the calendering treatment and only a product having low surface strength is obtained. When the average particle size is less than 0.5 μm, a long-term grinding treatment step is required, or the preparation method is complicated, and high cost is required. Also, the average particle size is preferably more than 4 μm because print density is enhanced.

Generally, vapor phase-process silica is more expensive than wet-process silica, and in the present invention, an inexpensive wet-process silica is preferably used. Among the wet-process silica, those prepared without passing through a drying step during the preparation are cheap and preferable.

An example of the method for preparing the wet-process silica prepared without passing through a drying step during the preparation includes the following method including two-stage type neutralization. As a matter of course, it is not intended to limit the scope of the present invention and a wet-process silica prepared by a method of carrying out neutralization in a single stage may also be used.

A wet-process silica is prepared, for example, by adding sulfuric acid, as sulfuric acid at a first stage, in an amount corresponding to 35 to 45% of the entire amount, which is required to neutralize sodium silicate, to an aqueous sodium silicate solution containing sodium sulfate added preliminarily therein, thereby partially neutralizing the aqueous sodium silicate solution; adjusting the concentration of silicon dioxide in the aqueous solution within a range from 6.0 to 8.0 g/100 ml and adjusting the concentration of sodium sulfate within a range from 3.5 to 4.1 g/100 ml; heating the aqueous solution to a temperature within a range from 85 to 95° C. with stirring; and adding mineral acid at a second stage, thereby completing neutralization.

The ink receiving layer preferably contains an amorphous silica in an amount within a range from 40 to 95% by mass (solid content), and more preferably from 60 to 90% by mass (solid content). When the amount is less than 40% by mass, it is difficult to obtain merits of low cost and high performances of the present invention. When the amount is more than 95% by mass, only a product having low surface strength is obtained.

The ink jet recording sheet characterized by containing an amorphous silica in an ink receiving layer of the present invention is characterized in that the ink receiving layer is subjected to a calendering treatment, thereby white-paper gloss measured at 75° in accordance with JIS Z 8741 of the surface of the ink receiving layer of the surface of the ink receiving layer is from 30 to 90%. In the calendering treatment, a conventional smoothing apparatus, for example, a super calender, a gloss calender, or a soft calender may be employed on machine or off machine. The type of the smoothing apparatus and the number of nipping operations and the smoothing temperature applied to the sheet are controlled so as to adjust the gloss within a range from 30 to 90%. Ink jet recording sheet characterized by containing wet-process silica in ink receiving layer

The wet-process silica used in the ink jet recording sheet characterized by containing the wet-process silica in the ink receiving layer is prepared by adding mineral acid in two stages to an aqueous sodium silicate solution containing sodium sulfate added preliminarily therein before initiating neutralization with mineral acid, thereby causing the neutralization reaction, and primary particles are mainly formed by the addition at a first stage, while secondary particles as an aggregate are formed by the addition at a second stage. In the present invention, it is extremely important to adjust the reaction conditions of the process for forming particles so as to obtain silica suited for use as a material for ink receiving layer.

In case primary particles of hydrous silicic acid do not sufficiently grow after a first neutralization with sulfuric acid by separating the neutralization with sulfuric acid in two stages, uniform neutralization reaction can be carried out according to the retention time until transfer to the second neutralization or the second neutral condition with sulfuric acid.

In the present invention, mineral acid is used in an amount corresponding to 35 to 45% of the neutralization equivalent at the first stage of the second addition of mineral acid and is added to the aqueous sodium silicate solution containing sodium sulfate added preliminarily therein with stirring. The concentration of the mineral acid is not specifically limited, but is usually from 10 to 30% by mass. The precipitation rate of the hydrous silicic acid (silica) is influenced by the temperature of the system and the concentration and the addition rate of the mineral acid. The higher the temperature, the concentration, and the addition rate of sulfuric acid, the higher the precipitation rate. In the present invention, the time required to add the mineral acid is not specifically limited, but is preferably from 8 to 15 minutes under conventional stirring conditions so as to prevent partial precipitation or gelation of the hydrous silicic acid (silica), and is preferably 60° C. or lower. After the addition of the mineral acid at the first stage, the aqueous solution is heated to a temperature within a range of 85 to 95° C. with stirring. In this case, since the concentration of silicon dioxide (SiO₂) and that of sodium sulfate (Na₂SO₄) exert a large influence on the viscosity of the hydrous silicic acid (silica) slurry and performances of the hydrous silicic acid (silica), the concentration of sodium silicate and the amount of an aqueous sodium sulfate solution added are adjusted so as to adjust the concentration of silicon dioxide (SiO₂) within a range of 6.0 to 8.0 g/100 ml and to adjust the concentration of sodium sulfate (Na₂SO₄) within a range of 3.5 to 4.1 g/100 ml. When the concentration of silicon dioxide (SiO₂) is less than 6.0 g/100 ml, a sheet having desired ink jet suitability (ink absorptivity) cannot be obtained because of lack or aggregation of primary particles of the hydrous silicic acid (silica). On the other hand, when the concentration of silicon dioxide (SiO₂) is more than 8.0 g/100 ml, aggregation of primary particles rapidly occur, and thus a desired effect cannot be obtained because of insufficient and non-uniform chemical reaction in the particles.

The addition of sodium sulfate to the reaction system exerts the effect of suppressing thickening of the system in the temperature rising step and decreasing the viscosity of the resulting hydrous silicic acid (silica), thereby increasing processing capacity in the post-process such as wet grinding and wet classification. The concentration of sodium sulfate in the aqueous solution of less than 3.5 g/100 ml is not preferable because the viscosity of the slurry increases thereby causing deterioration of the processing capacity in the post-process such as wet grinding and wet classification. On the other hand, the concentration of sodium sulfate in the aqueous solution of more than 4.1 g/100 ml is not preferable because the primary particle size increases and an ink jet recording sheet using this hydrous silicic acid (silica) results in a rough coated surface, dust fall and contamination of the guide roll.

In case of the wet-process silica, primary particles of the hydrous silicic acid (silica) having a particle size of 10 to 50 nm aggregate to form secondary particles and the size and number of fine pores formed in the aggregate vary depending on the size of the particle diameter of the primary particles, and thus the pore volume varies. In the wet-process silica of the present invention, the diameter of primary particles is preferably from 30 to 40 nm and therefore the amount of sulfuric acid at the first stage is essentially within a range from 35 to 45% of the neutralization equivalent. By the way, when the amount of sulfuric acid at the first stage is less than 35%, the pore volume does not reach a sufficient value because of insufficient growth of primary particles, and thus desired ink jet suitability (ink absorptivity) cannot be obtained. On the other hand, when the proportion of sulfuric acid at the first stage is 45% or more, the pore volume reaches a sufficient value and therefore desired ink jet suitability (ink absorptivity) can be obtained. However, the viscosity of the resulting slurry of hydrous silicic acid (silica) remarkably increases and handling becomes very difficult, for example, efficiency of wet grinding and wet classification deteriorate, and therefore it is not suitable.

Temperature rise after the neutralization at the first stage is carried out so as to promote precipitation of hydrous silicic acid (silica) particles. The temperature rising rate is not specifically limited. In case of a rapid temperature rise at a temperature gradient of 3° C./min, it is preferred that aging of primary particles is carried out by allowing them to stand for 5 to 10 minutes before transfer to the neutralization at a second stage after temperature rise (termination of growth of primary particles and formation of secondary particles). However in the case of a mild temperature rise at a temperature gradient of 1° C./min, it is not necessary to allow the particles to stand for several minutes. In the most preferred embodiment of the present invention, the neutralization at a first stage is completed at a temperature of 40 to 50° C. and the temperature is raised to 85 to 95° C. at a rate of 1.5 to 2.5° C./min over 20 to 30 minutes, and then the neutralization at a second stage is immediately carried out.

In the present invention, although the reaction is completed by the neutralization at a second stage, the addition of mineral acid at a second stage is usually carried out over 20 to 40 minutes. However, the addition rate is not specifically limited.

Examples of the mineral acid used for neutralization include inorganic acids, such as sulfuric acid, hydrochloric acid, and nitric acid, among which sulfuric acid is preferably used.

After the completion of the neutralization at the second stage, the coating solution for ink receiving layer can be prepared by mixing the hydrous silicic acid (silica) slurry with a binder as it is. Also, a coating solution for ink receiving layer can be prepared by filtering the hydrous silicic acid (silica) using a filter such as a belt filter, a filter press or a screw press to remove sodium sulfate, adding water to the resulting cake, mixing with stirring to give a slurry having a solid content of 8 to 12% by weight, and mixing the slurry with a binder. After the filtration, the resulting cake may be added after washing with water. The filtration is commonly carried out at the slurry temperature within a range from 40 to 60° C. taking account of the filtration rate and change in properties of the hydrous silicic acid. When the temperature of the slurry is lower than 40° C., the filtration rate decreases. The temperature of the slurry of higher than 60° C. is not preferred because properties of the hydrous silicic acid (silica) change and performances deteriorate.

When the coating solution for the ink receiving layer is prepared by mixing with a binder without being filtered and washed with water, there is a tendency that the resulting coating solution has a lower viscosity than that prepared by passing through the step of filtering and washing with water. As a result, a coating solution having higher concentration can be used and the coating rate increases, and is preferred. When the coating solution for ink receiving layer is prepared by mixing with a binder without being washed with water after filtration, the resulting coating solution has higher viscosity than that prepared without passing through the step of filtering and washing with water. However, there is a tendency that the resulting coating solution has a lower viscosity than that prepared by passing through the step of filtering and washing with water, and it is preferred.

Before or after removing sodium sulfate, the particle size of the slurry of the hydrous silicic acid (silica) is optionally reduced by treating with a wet grinder such as a continuous homomixer, a colloid mill, a disk refiner, a sand grinder, a ball mill or a rod mill. Also, particles having a large particle size are removed by treating with a classifier such as a vibrating screen.

Among the above wet-process silica, particularly preferable wet-process silica has an average particle size of 0.2 to 10 μm, and preferably more than 4 μm and 10 μm or less, particles having a particle size of 30 μm or less accounting for at least 70% or more of the entire particles. The average particle size of less than 0.2 ∞m is not preferred because the specific surface area increases and thus fluidity of the slurry deteriorates and the viscosity of the coating solution for ink receiving layer increases. When the average particle size is more than 10 μm, the coating layer of the resulting ink jet recording sheet has small surface strength and thus there may be a problem such as dust fall. The reason for this problem is not certain, but it is considered that the binder is less likely to penetrate into the gap between secondary particles of the grown silica or that secondary particles are likely to collapse, and thus surface strength is likely to decrease.

As the viscosity of the slurry decreases, the treating efficiency of wet grinding and classification of the hydrous silicic acid (silica) increases, and an operation of decreasing the viscosity is appropriately carried out, if necessary. For example, the pH value is adjusted within a range from 4 to 5 by adding aluminum sulfate (Al₂(SO₄)₃) to the slurry which is obtained by dispersion of the cake obtained by filtration again.

In the present invention characterized by containing a wet-process silica, since the coating solution for ink receiving layer is prepared by using the silica prepared without passing through the drying step, there are following disadvantages. Namely, the step of dispersing the powder again can be omitted and problems such as scatter and contamination caused when using a silica powder do not occur, and also a coating material can be prepared within a short time and the quantity of water and energy used for stirring can be reduced.

The wet-process silica is usually mixed in the coating solution for ink receiving layer in an amount within a range from 45 to 98% by mass (solid content). The amount of the wet-process silica is preferably from 60 to 90% by mass (solid content). When the amount of the wet-process silica is less than 45% by mass, it is difficult to obtain the merits of the present invention, i.e., low cost and high performances. When the amount is more than 98% by mass, the resulting product is excellent in cost and ink jet suitability, but may be inferior in surface strength.

### Miscellaneous

The ink receiving layer of the ink jet recording sheet of the present invention, which is characterized by containing an amorphous silica or a wet-process silica in the ink receiving layer, may optionally contain other pigments, except for the amorphous silica and the wet-process silica. Examples of the pigment include various pigments known in the field of the preparation of general coated paper, for example, inorganic pigments such as other silica (e.g. crystalline silica, vapor phase-process silica, etc.), kaolin, clay, calcined clay, zinc oxide, aluminum oxide, aluminum hydroxide, calcium carbonate, satin white, aluminum silicate, alumina, zeolite, synthetic zeolite, sepiolite, smectite, synthetic smectite, diatomaceous, magnesium silicate, magnesium carbonate, magnesium oxide, silica composite calcium carbonate obtained by supporting silica on calcium carbonate, and silica composite kaolin obtained by supporting silica on kaolin; and organic filled or hollow plastic pigments, for example, plastic pigments made of polymers such as styrene, ethylene, vinyl chloride, polyurethane, acryl, vinyl acetate, polycarbonate, and nylon, and copolymers thereof, urea resin-based plastic pigments, and benzoguanamine-based plastic pigments. These pigments can be used alone or in combination.

Among these pigments, hollow plastic pigments exert a large effect of improving white-paper gloss and plastic pigments having a hollow ratio of 51% or more exert particularly large effect. Also, hollow plastic pigments having an average particle size of 5 μm or less exert a large effect of improving white-paper gloss and hollow plastic pigments made of a resin having a glass transition point within a range from 30 to 120° C. exert a large effect of improving white-paper gloss.

Other pigments are usually mixed in the amount within a range of 0 to 50% by mass (solid content). When the amount is more than 50% by mass, it is hard to obtain the advantageous high performances of the present invention.

Examples of the binder of the ink receiving layer include starches such as cationic starch, amphoteric starch, oxidized starch, enzyme-modified starch, thermochemically modified starch, esterified starch and etherified starch; cellulose derivatives such as carboxymethyl cellulose and hydroxyethyl cellulose; natural or semisynthetic polymer compounds such as gelatin, casein, soybean protein and natural rubber; polydienes such as polyvinyl alcohol, polyisoprene, polyneoprene and polybutadiene; polyalkenes such as polybutene, polyisobutylene, polypropylene and polyethylene; vinyl-based polymers and copolymers, such as vinyl halide, vinyl acetate, (meth)acrylic acid, (meth)acrylate ester, (meth)acrylamide and methyl vinyl ether; synthetic rubber latexes such as styrene-butadiene-based latex and methyl methacrylate-butadiene-based latex; and synthetic resins such as polyurethane-based resin, polyester-based resin, polyamide-based resin, olefin-maleic anhydride-based resin and melamine-based resin. Among these binders, binders are appropriately selected and used alone or in combination.

The binder is usually mixed in the ink receiving layer in the amount within a range from 5 to 50% by mass (solid content). The amount of the binder is preferably from 10 to 30% by mass (solid content). When the amount of the binder is less than 5% by mass, it is difficult to obtain sufficient surface strength. When the amount of the binder is more than 50% by mass, only a product having poor ink absorptivity is obtained.

The ink receiving layer can contain a cationic or anionic substance having an action capable of enhancing fixation properties of the ink receiving layer with an ink according to ionicity of the ink. Examples of the cationic substance include cationic resins such as polyalkylene polyamine-based resin, or derivatives thereof, acrylic resin having a tertiary amino group or a quaternary ammonium group, polyethyleneimine-based resin, polyamide-based resin, polyamideepichlorohydrin-based resin, polyamineepichlorohydrin-based resin, polyamidepolyamineepichlorohydrin-based resin, polydiallylamine-based resin, polyamine-based resin and dicyandiamide condensate. Specifically, it is possible to use preferably cationic polymers such as poyethyleneamine, polypropylenepolyamine, dicyandiamide-polyethyleneamine, dicyandiamideformaldehyde, diacrylamine, cationic polyvinyl pyrrolidone, poly-trimethylammonium methacrylate, vinylimidazolium methachloride-vinyl pyrrolidone copolymer, diallyldimethyl quaternary ammonium hydrochloride, dicyandiamide-polyethyleneamine, dimethylaminopropylacrylamide-methyl chloride quaternary salt polymer, acrylamide-diallylamine copolymer, polyoxypropyl quaternary ammonium salt, diallyldimethylammonium hydrochloride-acrylamide copolymer, polydimethylamine-ammonia-epichlorohydrin, dimethylaminopropylacrylamide polymer, polyalkoxydialkyl quaternary ammonium salt, monoallylamine-diallylamine hydrochloride copolymer, polyallylamine hydrochloride, dicyandiamide-formaline polycondensate, dicyandiamide-diethylenetriamine polycondensate, epichlorohydrin-dimethylamine addition polymer, dimethyldiallylammonium chloride SO₂ copolymer, diallylamine salt SO₂ copolymer, dimethyldiallylammonium chloride polymer, polymer of allylamine salt, dialkylaminoethyl (meth)acrylate quaternary salt polymer and acrylamide-diallylamine salt copolymer.

Also, examples of the anionic substance include water insoluble metal salts of phosphotungstic acid and phosphomolybdic acid; ammonium salts of styrene-maleic anhydride copolymer; ammonium salts of α-olefin-maleic anhydride copolymer; and anionic polymers such as anion modified PVA and carboxymethyl cellulose.

If necessary, the ink receiving layer is appropriately mixed with various auxiliaries such as surfactants, pH adjustors, viscosity modifiers, softening agents, brightening agents, waxes, dispersants, flow modifiers, stabilizers, antistatic agents, crosslinking agents, sizing agents, fluorescent whitening agents, colorants, ultraviolet absorbers, defoamers, water resistant additives, plasticizers, lubricants, antiseptics and perfumes.

The amount of the coating solution for ink receiving layer to be coated on a substrate is preferably 1 to 15 g/m² per one surface in terms of the solid content. When the amount of the coating solution is less than 1 g/m², only a product having poor white-paper gloss is obtained even when subjected to a calendering treatment. The amount of the coating solution of more than 15 g/m² is not preferable because desired performances are obtained, but the cost increases.

The coating solution for the ink receiving layer is usually coated on a substrate using a conventional coating apparatus, for example, a blade coater, an air knife coater, a spray coater, a roll coater, a reverse roll coater, a bar coater, a curtain coater, a die slot coater, a gravure coater, a champlex coater, a metering blade type size press coater, bill blade coater, a short dwell coater, a rip coater and a gate roll coater. The coating may be applied on-machine or off-machine.

The substrate used in the present invention is not specifically limited and includes, for example, a sheet-like paper substrate, a film, and a material obtained by connecting a film with a sheet-like paper substrate. The substrate is preferably a sheet whose surface has water absorptivity. In particular, the substrate is preferably a substrate having water absorbency, which is measured by a Cobb method in case of contact time with water of 30 seconds defined in JIS P8140, of 15 to 400 g/m², and more preferably 17 to 300 g/m². In the case of using a substrate having water absorbency measured by a Cobb method of less than 15 g/m², the resulting sheet is suitable for practical use, but is slightly inferior in ink absorptivity. When water absorbency is more than 400 g/m², gloss may deteriorate because a large amount of the coating solution penetrates into a base paper.

The method for preparation of any kind of a pulp constituting the sheet like paper substrate are not specifically limited and chemical pulps such as KP, mechanical pulps such as SGP, RGP, BCTMP and CTMP, waste paper pulps such as deinking pulps, and non-wood pulps such as kenaf, bamboo, straw and flax pulps may be used. Also, the pulps may be used in combination with synthetic organic fibers such as polyamide and polyester fibers, regenerated fibers such as polynosic fibers, and inorganic fibers such as glass, ceramic and carbon fibers. Preferably, chlorine-free pulps such as ECF pulp and TCF pulp are used.

If necessary, the sheet-like paper substrate may be mixed with fillers. As for fillers, it is possible to use various pigments commonly used in wood free paper sheets. The pigments usable as the filler include inorganic pigments such as kaolin, calcined kaolin, calcium carbonate, calcium sulfate, barium sulfate, titanium dioxide, talc, zinc oxide, alumina, magnesium carbonate, magnesium oxide, silica, white carbon, bentonite, zeolite, sericite and smectite; and organic hollow, filled and perforated fine pigment particles of a polystyrene-based resin, a urea-based resin, a melamine-based resin, an acrylic resin and a vinylidene chloride-based resin.

In the production of the sheet-like paper substrate, the pulp slurry may contain, in addition to pulp fibers and fillers, various inner additives for the paper-making method, for example, anionic, nonionic, cationic and ampholytic yield-enhancing agents, filtration-enhancing agents, strength-enhancing agents and inner sizing agents, if necessary. The pulp slurry may further contain inner additives for paper-making process, for example, dyes, fluorescent brightening agents, pH adjustors, defoamers, pitch-controlling agents and slime-controlling agents, if necessary.

The method for producing the sheet-like paper substrate is not specifically limited. The sheet-like paper substrate may be produced by any paper-making methods, including an acid paper-making method in which the paper making is carried out at a pH of about 4.5, and a neutral paper-making method in which the pulp slurry contains an alkaline filler such as calcium carbonate as a main component and the paper making is carried out in the pH range of from a weak acidic pH value of about 6 to a weak alkaline pH value of about 9. The paper-making machine can be selected from a Fourdrinier paper machine, a twine-wire paper machine, a cylinder paper machine and a Yankee paper machine.

The weight (basis weight) of the sheet-like paper substrate used in the present invention is not specifically limited and is usually within a range from 30 to 200 g/m².

Examples of the film used as the substrate in the present invention include an acetate film, a cellulose triacetate film, a nylon film, a polyester film, a polycarbonate film, a polystyrene film, a polyphenylene sulfide film, a polypropylene film, a polyimide film and cellophane If necessary, the film may contain additives, for example, inorganic pigments, organic pigments, ultraviolet absorbers, antioxidants, fluorescent dyes, crosslinking agents, lubricants and releasants. The method for producing a film is not specifically limited and a known method can be used. The film used in the present invention includes so-called synthetic papers. The thickness of the film used as the substrate is not specifically limited, but is usually from 50 to 300 μm.

The material obtained by connecting a film used as the substrate in the present invention with a sheet-like paper substrate can be obtained by a known method. The thickness of the material obtained by connecting a film used as the substrate with a sheet-like paper substrate is not specifically limited and is usually from 50 to 300 μm.

The ink jet recording sheet of the present invention comprises a substrate and an ink receiving layer formed on one or both surfaces of the substrate, and the coating on one surface can be carried out twice or more. When the coating layer is formed on both surfaces of the substrate or in the multi-layered structure, the compositions and amount of a plurality of the coating layers may not be the same as each other. If necessary, the coating layer other than the ink receiving layer may be formed on the substrate. For example, when fixation properties of the ink receiving layer to the ink is further improved, or the substrate has low water absorptivity determine by a Cobb method, or peeling is likely to occur because of poor adhesion between the ink receiving layer and the substrate, an undercoat layer formed mainly of a cationic polymer or an anionic polymer or an undercoat layer formed mainly of a pigment and an adhesive can be formed before forming the ink receiving layer. Examples of the cationic polymer or anionic polymer used in the undercoat layer include the same cationic polymer or anionic polymer listed as the material of the coating solution for ink receiving layer. These polymers are used alone or in combination with a nonionic polymer such as starch or polyvinyl alcohol. Examples of the pigment and adhesive used in the undercoat layer include the same pigment and adhesive listed as the material of the coating solution for ink receiving layer. When the ink receiving layer is formed on only one surface of the substrate, various coating layers can be formed on the back surface of the substrate for the purpose of preventing antistatic charge, preventing curling, improving adhesion, imparting printability and improving resistance to blocking of feeding and/or delivering of the coated paper sheets into or from the printer. When the ink receiving layer is formed on only one surface of the substrate, the back surface of the substrate may be treated with an adhesive, a magnetic material, a flame retardant agent, a thermal resistant agent, a water-proofing agent, an oil-proofing agent or an anti-slipping agent so as to impart a desired function to the back surface.

For the ink jet recording sheet characterized by containing a wet-process silica in an ink receiving layer of the present invention, the coated paper is optionally subjected to a calendering treatment. In the calendering treatment, a conventional smoothing apparatus, for example, a super calender, a gloss calender, or a soft calender may be employed on machine or off machine. The type of the smoothing apparatus and the number of nipping operations and the smoothing temperature applied to the coated paper are controlled according to the expected paper quality, but are not specifically limited. In the present invention, the 75° specular glossiness of the surface of the ink receiving layer must be controlled to 30% or more measured in accordance with JIS Z 8741. The silica used in the present invention has an advantage that it is excellent in balance between gloss and color developability of the surface of the ink receiving layer after subjecting to the calendering treatment to the silica obtained by the other production method. The calendering treatment is applied to the substrate at least once after forming the ink receiving layer, but may be applied to the substrate before forming the ink receiving layer.

### EXAMPLES

The present invention will now be described by the following examples and is not limited to the scope of the present invention, as a matter of course. Parts and percentages in the examples are by weight unless otherwise specified.

### Ink Jet Recording Sheet Containing Amorphous Silica in Ink Receiving Layer

### Example 1

### [Production of Sheet-Like Substrate]

To 100 parts of a pulp slurry of LBKP (freeness (CSF)=450 ml), 0.05 parts of an alkenyl succinic anhydride (trade name: FIVERUN 81K, manufactured by Arakawa Chemical Industries, Ltd.) as an inner sizing agent, 0.7 parts of a cationic starch (Oji Ace K, manufactured by Oji Cornstarch Co., Ltd.) as a fixing agent and 0.5 parts of aluminum sulfate were added and also 10 parts of calcium carbonate as a filler was added, and then the resulting mixture was diluted with white water to prepare a pulp slurry having a pH value of 7 and a solid content of 0.8%. The pulp slurry was fed into a Fourdrinier paper machine and the resulting wet paper sheet was coated with a sizepress solution containing 6% of an oxidized starch (Trade name: Oji ACE A, manufactured by Oji Cornstarch Co., Ltd.) and dried by using a sizepress machine to render the paper sheet in a dry solid amount of 2 g/m². The resulting paper sheet was subjected to a smoothing treatment using a machine calender to control Bekk smoothness of the paper sheet to 50 seconds. Thus, a sheet-like substrate having a basis weight of 56 g/m² was produced.

### [Preparation of Coating Solution for Ink Receiving Layer]

200 Parts of an amorphous silica having an average particle size of 100 μm (trade name: Tokuseal NR, manufactured by TOKUYAMA Corp.) was dispersed in water, followed by a sand grinder treatment to prepare a pigment slurry having an average particle size of 3 μm. To the pigment slurry in the amount corresponding to 100 parts of a pigment, 50 parts of an acrylate ester-based emulsion (trade name: Mowinyl 718, manufactured by Clariant Polymers K.K.) as a binder and 12 parts of a polyamine-epichloro-based cation resin (trade name: DK-6854, manufactured by SEIKO PMC CORPORATION) were added, followed by stirring and addition of water to prepare a coating solution for ink receiving layer, which has a solid content of 15%.

### [Formation of Ink Receiving Layer on Sheet-Like Substrate]

The resulting coating solution was coated on both surfaces of the sheet-like substrate using an air knife coater and dried to form ink receiving layers each having a dry solid amount of 7 g/m².

### [Calendering Treatment]

The resulting sheet comprising an ink receiving layer formed thereon was passed through a pressure nip composed of a metal roll and an elastic roll to obtain an ink jet recording sheet having a basis weight of 141 g/m².

### Example 2

In the same manner as in Example 1, except that the pigment slurry having an average particle size of 3 μm after subjecting an amorphous silica to a sand grinder treatment was replaced by a pigment slurry having an average particle size of 5 μm, an ink receiving layer was formed and then subjected to a calendering treatment under the same conditions as in Example 1 to obtain an ink jet recording sheet.

### Example 3

In the same manner as in Example 1, except that the pigment slurry having an average particle size of 3 μm after subjecting an amorphous silica to a sand grinder treatment was replaced by a pigment slurry having an average particle size of 1 μm, an ink receiving layer was formed and then subjected to a calendering treatment under the same conditions as in Example 1 to obtain an ink jet recording sheet.

### Example 4

In the same manner as in Example 1, except that the pigment slurry having an average particle size of 3 μm after subjecting an amorphous silica to a sand grinder treatment was replaced by a pigment slurry having an average particle size of 10 μm, an ink receiving layer was formed and then subjected to a calendering treatment under the same conditions as in Example 1 to obtain an ink jet recording sheet.

### Example 5

In the same manner as in Example 1, except that 50 parts of polyvinyl alcohol (trade name: R1130, manufactured by Kuraray Co., Ltd.) was used in place of 50 parts of the acrylate ester-based emulsion (trade name: Mowinyl 718, manufactured by Clariant Polymers K.K.), an ink receiving layer was formed and then subjected to a calendering treatment under the same conditions as in Example 1 to obtain an ink jet recording sheet.

### Example 6

In the same manner as in Example 1, except that the pigment slurry having an average particle size of 3 μm after subjecting an amorphous silica to a sand grinder treatment was replaced by a pigment slurry having an average particle size of 4.2 μm, an ink receiving layer was formed and then subjected to a calendering treatment under the same conditions as in Example 1 to obtain an ink jet recording sheet.

### Example 7

In the same manner as in Example 1, except that the pigment slurry having an average particle size of 3 μm after subjecting an amorphous silica to a sand grinder treatment was replaced by a pigment slurry having an average particle size of 6 μm, an ink receiving layer was formed and then subjected to a calendering treatment under the same conditions as in Example 1 to obtain an ink jet recording sheet.

### Example 8

In the same manner as in Example 1, except that the pigment slurry having an average particle size of 3 μm after subjecting an amorphous silica to a sand grinder treatment was replaced by a pigment slurry having an average particle size of 9.3 ρm, an ink receiving layer was formed and then subjected to a calendering treatment under the same conditions as in Example 1 to obtain an ink jet recording sheet.

### Comparative Example 1

In the same manner as in Example 1, except that the pigment slurry having an average particle size of 3 μm after subjecting an amorphous silica to a sand grinder treatment was replaced by a pigment slurry having an average particle size of 12 μm, an ink receiving layer was formed and then subjected to a calendering treatment under the same conditions as in Example 1 to obtain an ink jet recording sheet.

### Comparative Example 2

In the same manner as in Example 1, except that the pigment slurry having an average particle size of 3 μm after subjecting an amorphous silica to a sand grinder treatment was replaced by a pigment slurry having an average particle size of 21 μm, an ink receiving layer was formed and then subjected to a calendering treatment under the same conditions as in Example 1 to obtain an ink jet recording sheet.

### Comparative Example 3

In the same manner as in Example 1, except that the calendering treatment was not carried out, an ink jet recording sheet was obtained.

With respect to the above nine kinds of ink jet recording sheets, the following evaluations were carried out. The results are summarized in Table 1.

### [Measurement of White-Paper Gloss of Ink Jet Recording Sheet]

In accordance with JIS Z8741, white-paper gloss of the ink jet recording sheet was measured under the conditions of an incidence angle of 75° and an acceptance angle of 75°. As a measuring device, a GLOSS METER, MODEL GM-26D, manufactured by MURAKAMI SHIKISAI KENKYUSHO was used.

### [Evaluation of Ink Jet Recording]

### [Ink Jet Printing]

Using an ink jet printer (PX-9000) manufactured by Epson Co. and standard ink as the ink, monochromatic or polychromatic (two, three and four colors) solid printing was carried out and ink absorptivity was visually evaluated.

### [Ink Absorptivity]

Immediately after printing, a white wood free paper was laid on the solid printed portion to obtain offset, and then the density of the offset image was evaluated by Macbeth Densitometer RD-914 and a black filter. The case where Macbeth density is 0.50 or less was rated good ink absorptivity and the case where Macbeth density is 0.30 or less was rated excellent ink absorptivity.

### [Evaluation of Surface Strength]

In the test, a Prufbau Printability Tester was used and a magenta ink having an ink intensity of T-13 was employed as an ink. Under adjusted conditions of the amount of ink of 0.5 g, a roll pressure of 40 kg, a blanket hardness of 40° and a printing speed of 1.0 m/sec, printing was carried out on the surface of an ink receiving layer and the surface strength was evaluated by visually judging white spots.

### [Evaluation of Print Density]

One day after printing, the density of the solid printed portion (four-color print density) was measured using a Macbeth Densitometer RD-914 and an average of four colors was recorded.

### [Criteria for Visual Judgment]

Excellent: white spots derived from coating layer did not occur, good
Good: slight white spots derived from coating layer occurred, practically satisfactory
Fair: white spots derived from coating layer occurred, practically unsatisfactory, sometimes
Poor: white spots derived from coating layer occurred, practically unsatisfactory
Failure: severe white spots derived from coating layer occurred, no commercial value

TABLE 1

| | | White- | | |
|---|---|---|---|---|
| | Ink | paper | Surface | Print |
| | absorptivity | gloss | strength | density |
| Example 1 | 0.10 | 60 | Good | 1.41 |
| Example 2 | 0.09 | 56 | Good | 1.42 |
| Example 3 | 0.15 | 62 | Excellent- | 1.35 |
| | | | Good | |
| Example 4 | 0.07 | 50 | Good | 1.44 |
| Example 5 | 0.20 | 32 | Good | 1.39 |
| Example 6 | 0.08 | 59 | Good | 1.44 |
| Example 7 | 0.08 | 58 | Good | 1.45 |
| Example 8 | 0.07 | 51 | Good | 1.47 |
| Comparative | 0.05 | 48 | Fair | 1.45 |
| Example 1 | | | | |
| Comparative | 0.04 | 60 | Poor | 1.47 |
| Example 2 | | | | |
| Comparative | 0.01 | 20 | Failure | 1.47 |
| Example 3 | | | | |

As is apparent from Table 1, the ink jet recording sheets of the present invention have high white-paper gloss and are also excellent in surface strength (Examples 1 to 8)

When the average particle size is more than 10 μm, the resulting ink jet recording sheets are inferior in surface strength (Comparative Examples 1, 2). When the calendering treatment is not carried out, the resulting ink jet recording sheet has low white-paper gloss and is inferior in surface strength (Comparative Example 3). Ink jet recording sheet containing wet-process silica in ink receiving layer

### Example 9

### [Preparation of Silica Slurry]

In a reaction vessel (300 liter), an aqueous sodium silicate solution (a molar ratio SiO₂/Na₂O=3.05, a SiO₂ concentration=20% by mass) was charged and diluted with water to prepare an aqueous dilute sodium silicate solution having a SiO₂ concentration of 8% by mass and, furthermore, sodium sulfate was added and dissolved. After the aqueous solution was heated to 45° C., dilute sulfuric acid having a concentration of 20% by mass was added dropwise at a dropping rate of 1.3 kg/min under vigorous stirring enough to prevent generation of a huge gel in an amount corresponding to 37% by mass of a neutralization equivalent, thereby completing neutralization at a first stage. After the dropwise addition, a silicon dioxide (SiO₂) concentration was 7.2 g/100 mol and a sodium sulfate (Na₂SO₄) concentration was 3.9 g/100 mol.

After the aqueous solution was heated to 95° C. and stirred for over 20 minutes, a dilute sulfuric acid having a concentration of 10% by mass was added dropwise at a dropping rate of 0.5 kg/min under vigorous stirring, thereby completing neutralization at a second stage. The resulting silica slurry had a pH value of 5.0.

### [Production of Sheet-Like Substrate]

To 100 parts of a pulp slurry of LBKP (freeness (CSF)=450 ml), 0.05 parts of an alkenyl succinic anhydride (trade name: FIVERUN 81K, manufactured by Arakawa Chemical Industries, Ltd.) as an inner sizing agent, 0.7 parts of a cationic starch (Oji Ace K, manufactured by Oji Cornstarch Co., Ltd.) as a fixing agent and 0.5 parts of aluminum sulfate were added and also 10 parts of calcium carbonate as a filler was added, and then the resulting mixture was diluted with white water to prepare a pulp slurry having a pH value of 7 and a solid content of 0.8%. The pulp slurry was fed into a Fourdrinier paper machine and the resulting wet paper sheet was coated with a sizepress solution containing 6% of an oxidized starch (Trade name: Oji ACE A, manufactured by Oji Cornstarch Co., Ltd.) and dried by using a sizepress machine to render the paper sheet in a dry solid amount of 2 g/m². The resulting paper sheet was subjected to a smoothing treatment using a machine calender to control the Bekk smoothness of the paper sheet to 50 seconds. Thus, a sheet-like substrate having a basic weight of 127 g/m² was produced.

### [Preparation of Coating Solution for Ink Receiving Layer]

The above silica slurry was ground into a slurry containing fine particles having an average particle size of 5 to 6 μm by subjecting to sand grinder treatment. To the slurry in the amount corresponding to 100 parts of a pigment, 50 parts of an acrylate ester-based emulsion (trade name: Mowinyl 718, manufactured by Clariant Polymers K.K.) as a binder and 12 parts of a polyamine-epichloro-based cation resin (trade name: DK-6854, manufactured by SEIKO PMC CORPORATION) were added, followed by stirring and addition of water to prepare a coating solution for ink receiving layer, which has a solid content of 15%.

### [Formation of Ink Receiving Layer on Sheet-Like Substrate]

The resulting coating solution was coated on both surfaces of the sheet-like substrate using an air knife coater and dried to form ink receiving layers each having a dry solid amount of 7 g/m².

### [Calendering Treatment]

The resulting sheet comprising an ink receiving layer formed thereon was passed through a pressure nip composed of a metal roll and an elastic roll to obtain an ink jet recording sheet having a basis weight of 141 g/m². The evaluation results of the resulting ink jet recording sheet are shown in Table 1.

### Example 10

A silica slurry before subjecting to a grinding treatment obtained in the same manner as in Example 9 was filtered using a centrifugal dehydrator to obtain a silica cake. The cake was taken out and water was added, followed by vigorous stirring to obtain a slurry having a concentration of 8% by mass. Subsequently, the slurry was ground into a slurry containing fine particles having an average particle size of 5 to 6 μm by subjecting to a sand grinder treatment. To the slurry in the amount corresponding to 100 parts of a pigment, 50 parts of an acrylate ester-based emulsion (trade name: Mowinyl 718, manufactured by Clariant Polymers K.K.) as a binder and 12 parts of a polyamine-epichloro-based cation resin (trade name: DK-6854, manufactured by SEIKO PMC CORPORATION) were added, followed by stirring and addition of water to prepare a coating solution for ink receiving layer, which has a solid content of 15%. Subsequently, in the same manner as in Example 9, except that the resulting coating solution was used, an ink jet recording sheet was obtained. The evaluation results of the resulting ink jet recording sheet are shown in Table 2.

### Example 11

A silica slurry before subjecting to a grinding treatment obtained in the same manner as in Example 9 was filtered using a centrifugal dehydrator and then washed to obtain a silica cake. The cake was taken out and water was added, followed by vigorous stirring to obtain a slurry having a concentration of 8% by mass. Subsequently, the slurry was ground into a slurry containing fine particles having an average particle size of 5 to 6 μm by subjecting to a sand grinder treatment. To the slurry in the amount corresponding to 100 parts of a pigment, 50 parts of an acrylate ester-based emulsion (trade name: Mowinyl 718, manufactured by Clariant Polymers K.K.) as a binder and 12 parts of a polyamine-epichloro-based cation resin (trade name: DK-6854, manufactured by SEIKO PMC CORPORATION) were added, followed by stirring and addition of water to prepare a coating solution for ink receiving layer, which has a solid content of 15%. Subsequently, in the same manner as in Example 9, except that the resulting coating solution was used, an ink jet recording sheet was obtained. The evaluation results of the resulting ink jet recording sheet are shown in Table 2.

### Comparative Example 4

In a reaction vessel (300 liter), an aqueous sodium silicate solution (a molar ratio SiO₂/Na₂O=2.18, a SiO₂ concentration=20% by mass) was diluted with water to prepare an aqueous dilute sodium silicate solution having a SiO₂ concentration of 5% by mass. After the aqueous solution was heated to 85° C., dilute sulfuric acid having a concentration of 10% by mass was added dropwise at a dropping rate of 270 g/min under vigorous stirring enough to prevent generation of a huge gel. From the point of time when the dilute sulfuric acid was added in an amount corresponding to 40% by mass of a neutralization equivalent, a close circuit grinding treatment was initiated by a horizontal sand grinder and a grinding treatment was carried out for 90 minutes in an amount corresponding to 80% by mass of a neutralization equivalent so as to attain a target particle size of 5 to 6 μm. After the completion of the grinding treatment, the dilute sulfuric acid having the same concentration was continuously added to the reaction solution at an addition rate of 270 g/min and the pH of the reaction solution was adjusted to 6 to obtain a silica slurry.

Next, the silica slurry was filtered and then washed with water to obtain a silica cake, followed by the addition of water and vigorous stirring to obtain a slurry having a concentration of 8% by mass. To the slurry in the amount corresponding to 100 parts of a pigment, 50 parts of an acrylate ester-based emulsion (trade name: Mowinyl 718, manufactured by Clariant Polymers K.K.) as a binder and 12 parts of a polyamine-epichloro-based cation resin (trade name: DK-6854, manufactured by SEIKO PMC CORPORATION) were added, followed by stirring and addition of water to prepare a coating solution for ink receiving layer, which has a solid content of 15%. Subsequently, in the same manner as in Example 9, except that the resulting coating solution was used, an ink jet recording sheet was obtained. The evaluation results of the resulting ink jet recording sheet are shown in Table 2.

### Comparative Example 5

(1) First neutralization step (neutralization rate: 40%); In a reaction vessel (300 liter), an aqueous sodium silicate solution (a molar ratio SiO₂/Na₂O=2.18, a SiO₂ concentration=20% by mass) was diluted with water to prepare an aqueous dilute sodium silicate solution having a SiO₂ concentration of 6.7% by mass. After the aqueous solution was heated to 85° C., an amount corresponding to 40% of a neutralization equivalent of dilute sulfuric acid (concentration of 98% by mass) was added dropwise at a dropping rate of 240 g/min under vigorous stirring enough to prevent generation of a huge gel. After the completion of dropwise addition, the resulting partially neutralized solution was subjected to an aging treatment and was simultaneously subjected to a close circuit grinding treatment using a horizontal sand grinder so as to attain a target particle size of 5 to 6 μm. (2) Second neutralization step (neutralization rate: 40%, integrated neutralization rate: 80%); While maintaining the temperature of the reaction solution at 85° C., the dilute sulfuric acid having the same concentration as in the first step was added in an amount corresponding to 80% by mass of a neutralization equivalent under the same conditions as in the first neutralization step. After the completion of dropwise addition, the resulting partially neutralized solution was subjected to an aging treatment under stirring for 30 minutes. (3) Third neutralization step (neutralization rate: 20%, integrated neutralization rate: 100%); Subsequently, the dilute sulfuric acid having the same concentration was similarly added to the aged reaction solution at an addition rate of 1640 g/min and the pH value of the reaction solution was adjusted to 6 to obtain a silica slurry.

Next, after the completion of the third step, the silica slurry was filtered and then washed with water to obtain a silica cake, followed by the addition of water and vigorous stirring to obtain a slurry having a concentration of 8% by mass. To the slurry in the amount corresponding to 100 parts of a pigment, 50 parts of an acrylate ester-based emulsion (trade name: Mowinyl 718, manufactured by Clariant Polymers K.K.) as a binder and 12 parts of a polyamine-epichloro-based cation resin (trade name: DK-6854, manufactured by SEIKO PMC CORPORATION) were added, followed by stirring and addition of water to prepare a coating solution for ink receiving layer, which has a solid content of 15%. Subsequently, in the same manner as in Example 9, except that the resulting coating solution was used, an ink jet recording sheet was obtained. The evaluation results of the resulting ink jet recording sheet are shown in Table 2.

### Comparative Example 6

A coating solution for ink receiving layer was prepared by mixing 100 parts of Mizukasil P705 (manufactured by MIZUSAWA INDUSTRIAL CHEMICALS, LTD.) with the same compounds as in Example 9 and then an ink jet recording sheet was obtained in the same manner as in Example 9. The evaluation results of the resulting ink jet recording sheet are shown in Table 2.

The resulting ink jet recording sheets were evaluated by the following methods.

### “White-Paper Gloss”

As described above, 75° specular gloss defined in JIS Z 8741 was measured.

### “Print Density”

Using an ink jet printer (PM-800G) manufactured by Epson Co. and a standard ink as the ink, black solid printing was carried out and ink density was measured by Macbeth RD914.

### “Handling Properties”

The state of scatter of silica upon preparation of a coating material was visually judged. The case where working environment is satisfactory because of less scatter was rated “Excellent” and the case where working environment is unsatisfactory because of severe scatter was rated “Failure”.

TABLE 2

| | White-paper | Print | Handling |
|---|---|---|---|
| | gloss | density | properties |
| Example 9 | 52 | 1.54 | Excellent |
| Example 10 | 53 | 1.52 | Excellent |
| Example 11 | 51 | 1.52 | Excellent |
| Comparative | 25 | 1.53 | Excellent |
| Example 4 | | | |
| Comparative | 44 | 1.32 | Excellent |
| Example 5 | | | |
| Comparative | 20 | 1.60 | Failure |
| Example 6 | | | |

As is apparent from Table 2, the ink jet recording sheets of the present invention have high white-paper gloss and high print density and are therefore excellent (Examples 9, 10 and 11). In case of using silica prepared by a synthesis method, which is different from that used in the present invention, deterioration of white-paper gloss (Comparative Example 4) and decrease in print density (Comparative Example 5) were recognized. Silica dried after the neutralization reaction was inferior in handling properties because it scatters in case of preparing a coating material using a stirrer such as Cowless dissolver (Comparative Example 6).

### INDUSTRIAL APPLICABILITY

An ink jet recording sheet characterized by containing an amorphous silica in an ink receiving layer of the present invention which has good ink jet recordability, high white-paper gloss, and high surface strength, and is also cheap and excellent in use. The ink jet recording sheet characterized by containing a wet-process silica in an ink receiving layer of the present invention is an ink jet recording sheet best suited for on-demand printing, which is excellent in handling properties of a pigment upon preparation of a coating material and is also excellent in white-paper gloss and color developability.

1. An ink jet recording sheet comprising a sheet-like substrate, and an ink receiving layer formed on at least one surface of the sheet-like substrate, the ink receiving layer containing an amorphous silica having an average particle size 0.5 to 10 μm and a binder, the sheet-like substrate being subjected to a calendering treatment after forming the ink receiving layer thereon, thereby white-paper gloss of the recording sheet measured at 75° in accordance with JIS Z 8741 is from 30 to 90%.

2. The ink jet recording sheet according to claim 1, wherein the average particle size of the amorphous silica is more than 4 μm and 10 μm or less.

3. The ink jet recording sheet according to claim 1, wherein the amorphous silica is a wet-process silica.

4. The inkjet recording sheet according to claim 3, wherein the wet-process silica is prepared without passing through a drying step during the preparation.

5. An ink jet recording sheet comprising a substrate, and an ink receiving layer formed on the surface of the substrate, the ink receiving layer containing a wet-process silica and a binder, wherein the wet-process silica is obtained by adding mineral acid having a neutralization equivalent of 35 to 45% to an aqueous sodium silicate solution containing sodium sulfate added preliminarily therein at a first stage, thereby partially neutralizing the aqueous sodium silicate solution, adjusting the concentration of silicon dioxide in the aqueous solution within a range from 6.0 to 8.0 g/100 ml and adjusting the concentration of sodium sulfate within a range from 3.5 to 4.1 g/100 ml, heating the aqueous solution to a temperature within a range from 85 to 95° C. with stirring, and adding mineral acid at a second stage, thereby completing neutralization, and the wet-process silica is obtained without passing through a drying step.

6. The inkjet recording sheet according to claim 5, wherein the wet-process silica is obtained by adding the mineral acid at the second stage, thereby completing neutralization and wet-grinding and/or wet-classifying the resulting slurry, and the wet-process silica is obtained without passing trough the drying step.

7. The inkjet recording sheet according to claim 5, wherein the wet-process silica is obtained by adding the mineral acid at the second stage, thereby completing neutralization, filtering the aqueous solution to obtain a silica cake and dispersing the silica cake again in water, and the wet-process silica is obtained without passing trough the drying step.

8. The inkjet recording sheet according to claim 5, wherein the wet-process silica is obtained by adding the mineral acid at the second stage, thereby completing neutralization, filtering the aqueous solution to obtain a silica cake, washing the silica cake with water and dispersing the silica cake again in water, and the wet-process silica is obtained without passing trough the drying step.

9. The ink jet recording sheet according to claim 7, wherein the wet-process silica is obtained by adding the mineral acid at the second stage, thereby completing neutralization, filtering the aqueous solution to obtain a silica cake, washing the silica cake with water or not, dispersing the silica cake again in water and wet grinding and/or wet classifying the silica cake, and the wet-process silica is obtained without passing through the drying step.

10. The ink jet recording sheet according to claim 9, wherein wet-process silica has an average particle size within a range from 0.2 to 10 μm and particles having a particle size of 30 μm or less account for 70% or more of the entire particles.

11. The ink jet recording sheet according to claim 2, wherein the amorphous silica is a wet-process silica.

12. The inkjet recording sheet according to claim 11, wherein the wet-process silica is prepared without passing through a drying step during the preparation.

13. The ink jet recording sheet according to claim 8, wherein the wet-process silica is obtained by adding the mineral acid at the second stage, thereby completing neutralization, filtering the aqueous solution to obtain a silica cake, washing the silica cake with water or not, dispersing the silica cake again in water and wet grinding and/or wet classifying the silica cake, and the wet-process silica is obtained without passing through the drying step.

14. The inkjet recording sheet according to claim 5, wherein wet-process silica has an average particle size within a range from 0.2 to 10 μm and particles having a particle size of 30 μm or less account for 70% or more of the entire particles.

15. The inkjet recording sheet according to claim 6, wherein wet-process silica has an average particle size within a range from 0.2 to 10 μm and particles having a particle size of 30 μm or less account for 70% or more of the entire particles.

16. The inkjet recording sheet according to claim 7, wherein wet-process silica has an average particle size within a range from 0.2 to 10 μm and particles having a particle size of 30 μm or less account for 70% or more of the entire particles.

17. The inkjet recording sheet according to claim 8, wherein wet-process silica has an average particle size within a range from 0.2 to 10 μm and particles having a particle size of 30 μm or less account for 70% or more of the entire particles.

18. The ink jet recording sheet according to claim 13, wherein wet-process silica has an average particle size within a range from 0.2 to 10 μm and particles having a particle size of 30 μm or less account for 70% or more of the entire particles.
